(19) United States
(12) Patent Application Publication
(10) Pub. No.: US 2007/0239656 A1
(43) Pub. Date: Oct. 11, 2007

(54) Removal of Database Query Function Calls

(76) Inventor: John M. Santosuosso, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 11/278,834

(22) Filed: Apr. 6, 2006

(51) Int. Cl. G06F 17/30

(52) U.S. Cl. 707/2

(57) ABSTRACT

Embodiments of the invention provide a method, article of manufacture, and an apparatus used to optimize a database query. Query tools often generate database queries that include unnecessary function calls. Embodiments of the invention provide a mechanism to analyze and remove function calls included in a database query. If removing an embedded function call will not alter a set of query results returned in response to the database query, then the query may be rewritten to remove the embedded function calls.

### BACKGROUND OF THE INVENTION

1. Field of the Invention

This application is generally related to computer database systems. More particularly, this application is related to evaluating database queries that include an embedded function call and, where appropriate, removing the function calls from the database query.

2. Description of the Related Art

Databases are computerized information storage and retrieval systems. A relational database management system (RDBMS) is a computer database management system that uses relational techniques for storing and retrieving data. Relational databases are computerized information storage and retrieval systems in which data in the form of tables are typically stored for use on disk drives or similar mass data stores. Each database table includes a set of rows (also referred to as records) spanning one or more columns.

A database query refers to a set of commands or clauses for retrieving data stored in a database. Database queries may come from users, application programs, or remote systems. A query may specify which columns to retrieve data from, how to join columns from multiple tables, and conditions that must be satisfied for a particular data record to be included in a query result set. Current relational databases typically process queries composed in an exacting format specified by a query language. For example, the widely used query language SQL (short for Structured Query Language) is supported by virtually every database available today.

Database queries, including SQL statements, often incorporate built-in (or embedded) function calls. Examples of built-in function supported by most database systems include aggregating calls such as MIN, MAX, and AVERAGE, which return the minimum, maximum, and average values of a column, respectively. Function calls also include non-aggregate calls like COALESCE, IS_DIGITS, DATE, CHAR, TO_CHAR. The particular collection and behavior of function calls varies by database vendor. Regardless of vendor, however, the purpose of these function calls is to translate data values passed into the function to potentially some other value. Typically, the inputs to a function call come from the values of a database column retrieved in response to a query. For example, a TO_UPPER function may take a text string of characters and return the same string, translating each character to an upper case value. If a query includes the condition: “WHERE <column value>=‘ABC’”, then including the embedded function “WHERE TO_UPPER(column value)=‘ABC’” will cause the values of the column to be converted to uppercase before being compared to the ‘ABC’ operand.

Embedded function calls may generally be located anywhere in an SQL statement (i.e., within the SELECT, FROM, WHERE, or GROUP BY clauses, among others). The use of embedded function calls adds overhead to the time required by a database system to process a database query. Thus, unnecessary function calls will degrade system performance. At the same time, many query applications are configured to insert function calls when composing a query. Oftentimes, this may occur because a query tool may not be able to determine whether or not a particular function call is necessary and includes the function calls just in case they end up being required.

Accordingly, there is a need in the art for a database query optimization mechanism that will remove unnecessary function calls embedded in a database query.

### SUMMARY OF THE INVENTION

Embodiments of the invention provide a mechanism to analyze and remove function calls included in a database query. One embodiment of the invention provides a computer-implemented method of optimizing a database query. The method may generally include, receiving a query of a database, wherein the query includes one or more embedded function calls, and determining whether one or more of the embedded function calls may be removed without modifying a set of results that will be generated in response to the database query. If so, the method generally includes rewriting the database query to remove one or more of the embedded function calls.

Another embodiment of the invention provides computer-readable medium containing a program which, when executed, performs an operation for optimizing a database query. The operation may generally include, receiving a query of a database, wherein the query includes one or more embedded function calls, and determining whether one or more of the embedded function calls may be removed without modifying a set of results that will be generated in response to the database query. If so, the operation generally further includes, rewriting the database query to remove one or more of the embedded function calls.

Still another embodiment of the invention provides a computing device. The computing device may generally include a processor and a memory containing a program, which, when executed, performs an operation for optimizing a database query. The operation may generally include, receiving a query of a database, wherein the query includes one or more embedded function calls, and determining whether one or more of the embedded function calls may be removed without modifying a set of results that will be generated in response to the database query. If so, the operation generally further includes, rewriting the database query to remove one or more of the embedded function calls.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof, which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a block diagram that illustrates a client server view of a computing environment and database system, according to one embodiment of the invention.

FIGS. 2A-2D illustrate exemplary database queries that include embedded function calls which may, under some circumstances, be removed without changing query results, according to one embodiment of the invention.

FIG. 3 illustrates a method for processing a database query, according to one embodiment of the invention.

FIG. 4 illustrates a method for evaluating function calls embedded within a database query, according to one embodiment of the invention.

### DETAILED DESCRIPTION OF THE PREFERRED EMBODIMENTS

Embodiments of the invention provide a mechanism to analyze function calls included in a database query. If removing such a call would not alter the results returned in response to the database query, then the query may be rewritten to remove the embedded function calls. Because performing function calls increases query execution time, the removal of any unnecessary function calls can enhance the overall speed of processing a database query. Additionally, in one embodiment, the analysis of embedded function calls is performed only if a query optimizer determines that removing the embedded function call could provide significant savings of query execution time.

Embodiments of the invention are described herein relative to the widely used SQL query language. However, the invention is not limited to optimizing SQL statements; rather, embodiments of the invention may be adapted to optimize database queries composed in other query languages that provide built in (or embedded) function calls, whether now known or later developed. Further, in the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

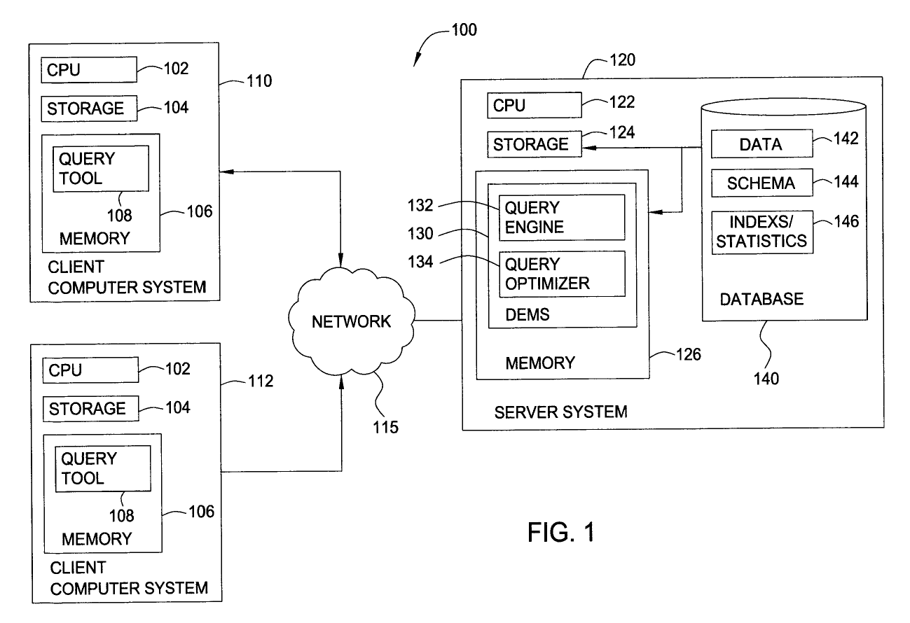

One embodiment of the invention is implemented as a program product for use with a computer system such as, for example, the computing environment 100 shown in FIG. 1 and described below. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD/DVD-ROM disks readable by a CD/DVD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

FIG. 1 is a block diagram that illustrates a client server view of computing environment 100, according to one embodiment of the invention. As shown, computing environment 100 includes two client computer systems 110 and 112, network 11 5 and server system 120. In one embodiment, the computer systems illustrated in environment 100 may include computer existing computer systems, e.g., desktop computers, server computers laptop computers, tablet computers, and the like. The software applications described herein, however, are not limited to any particular computing system or application or network architecture and may be adapted to take advantage of new computing systems as they become available. Additionally, those skilled in the art will recognize that the computer systems shown in FIG. 1 are simplified to highlight aspects of the present invention and that computing systems and networks typically include a variety of additional elements not shown in FIG. 1.

As shown, client computer systems 110 and 112 each include a CPU 102, storage 114 and memory 106, typically connected by a bus (not shown). CPU 102 is a programmable logic device that performs all the instruction, logic, and mathematical processing in a computer. Storage 104 stores application programs and data for use by client computer systems 110 and 112. Storage 104 includes hard-disk drives, flash memory devices, optical media and the like. Network 115 generally represents any kind of data communications network. Accordingly, network 115 may represent both local and wide are networks, including the Internet. Client computer systems 110 and 112 are also shown to include a query tool 108. In one embodiment, the query tool 108 is software application that allows end users to access information stored in a database (e.g., database 140). Accordingly, query tool 108 may allow users to compose and submit a query to a database system, which, in response, may be configured to process the query and return a set of query results. In one embodiment, the query tool allows users to compose a database query without requiring that the user also be familiar with the underlying database query language (e.g., SQL). In such a case, the query tool 108 may be configured to generate a query in the underlying query language based on input provided by a user.

Server 120 also includes a CPU 122, storage 124 and memory 126. As shown, sever computer 120 also includes a database management system (DBMS) 130 that includes a query engine 132 and query optimizer 134 in communication with database 140. The DBMS 130 includes software used to organize, analyze, and modify information stored in a database 140. The query engine 132 may be configured to process database queries submitted by a requesting application (e.g., a query generated using query tool 108) and to return a set of query results to the requesting application. The query optimizer 134 may be configured to take a query received from the requesting application and optimize the query prior to its execution by the query engine 132. In one embodiment, the query optimizer 134 may evaluate any embedded function calls included in a database query to determine whether one or more such function calls may be removed without changing the results of the query.

Database 140 contains the data managed by DBMS 130. At various times elements of database 140 may be present in storage 124 and memory 126. In one embodiment, database 140 includes data 142, schema 144 and indexes/statistics 146. Data 142 represents the substantive data stored by database 140. Schema 144 provides description of how the data 142 is represented and organized within a database 140. For a relational database, the schema 144 specifies the tables, columns, and relationships between tables. In addition, schema 144 may specify the data types of columns in a table and any constraints on a table or column. For example, schema 144 may specify a range of allowable values for a column or whether entries in a column may include a null value. Index/statistics 146 may include various elements of metadata regarding database 140. For example, index/statistics 146 may store how many records are in a particular table, information such as the minimum, maximum, or average of values in a column. Statistics may also be maintained regarding queries submitted to the database 140. For example, information such as how many times a particular query has been submitted to the DBMS 130 may be maintained.

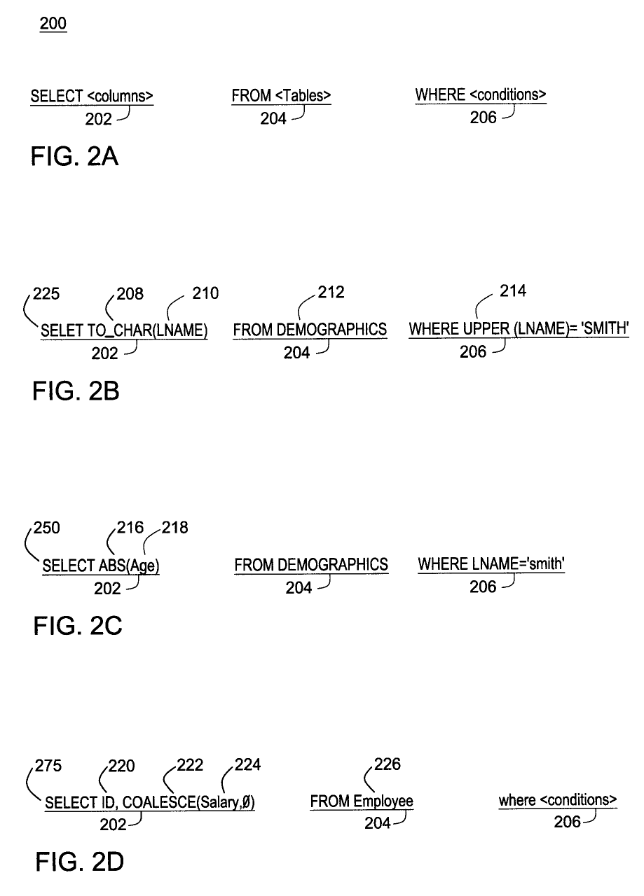

FIGS. 2A-2D illustrate exemplary database queries that include embedded function calls which, in some cases, may be removed from the queries, according to one embodiment of the invention. As shown in FIGS. 2A-2D, database queries 200, 225, 250, and 275 are composed using the SQL query language. As stated above, however, embodiments of the invention may be adapted for use with other query languages that provide built-in (or embedded) function calls, whether now known or later developed.

First, FIG. 2A illustrates the general structure of an SQL query. The SQL query 200 includes a SELECT clause 202, a FROM clause 204, and a WHERE clause 206. Generally, a SELECT clause 202 lists a set of one or more <columns> from which data records should be returned in response to a database query. FROM clause 204 is used to indicate from which <tables> the data is to be retrieved, as well as how different tables should be joined to each other. The WHERE clause 206 is used to specify one or more <conditions> used to determine which rows to be returned in response to a given query. Those, skilled in the art will recognize that the SQL language supports additional clauses (e.g., HAVING, GROUP BY, ORDER BY).

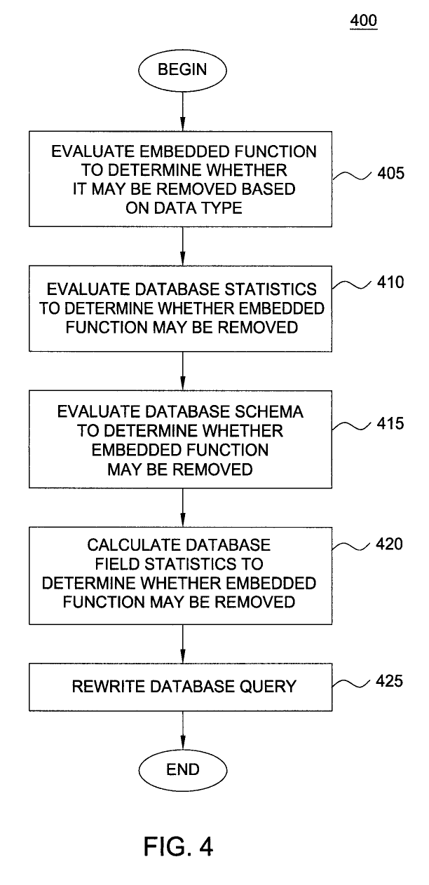

FIG. 2B-2D illustrate exemplary database queries 225, 250, and 275 with examples of the <columns>, <tables>, and <conditions> values for the SELECT, FROM, and WHERE clauses of query 200. Additionally, each of database queries 225, 250, and 275 include one or more embedded function calls. In one embodiment, when processing database queries 225, 250, and 275, query optimizer 134 may evaluate whether these embedded function calls may be removed. The specific examples included in database queries 225, 250, and 275 are described in detail below in conjunction with the method illustrated in FIG. 4.

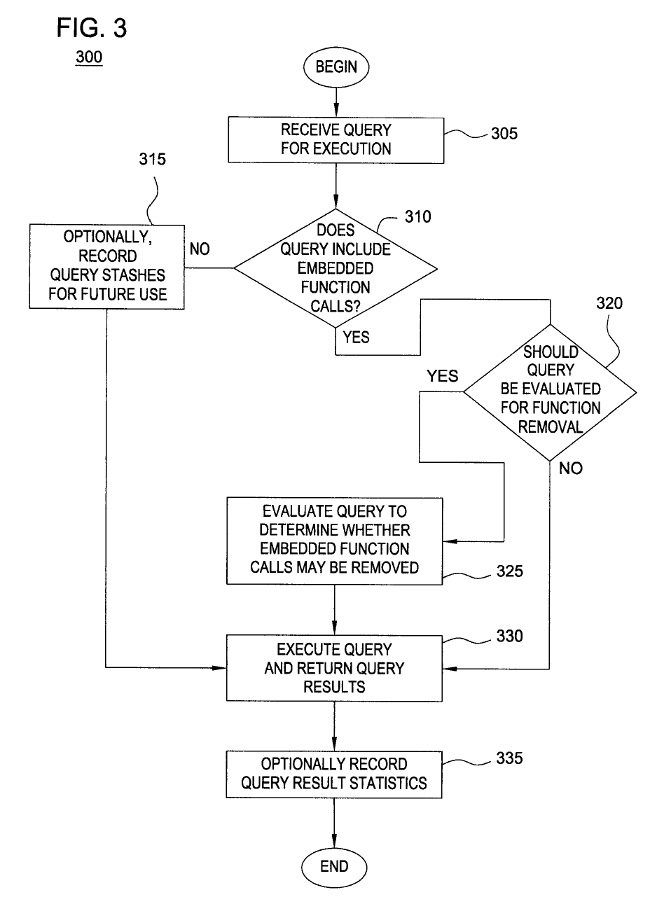

FIG. 3 illustrates a method 300 for processing a database query, according to one embodiment of the invention. The method 300 begins at step 305 when the DMBS 130 receives a database query for execution. In one embodiment, the query may be received over network 115 from query tool 108. At step 310, the query engine 132 may be configured to parse the query received at step 305 and determine whether the query includes any embedded function calls. If the query does not include any embedded function calls, then the query engine 132 may be configured to record query statistics for future use (step 315). For example, query statistics may be gathered to determine how frequently a given query is executed, or what tables, or columns, or conditions are referenced by a particular query.

Otherwise, when the query received at step 305 includes one or more embedded function calls, the query optimizer 134 may determine whether to evaluate if one or more function calls may be removed. For example, assume the query optimizer 134 determines that the query received at step 305 is expected to return a small number (which may be predetermined) of rows, or even a single row. Performing an embedded function over one column of a small number of rows is not likely to cause a substantial performance drain. In such a case, determining whether to remove the embedded function call may become more costly (in terms of query execution time) than it would be to simply run the embedded function. Sometimes however, an embedded function may be sufficiently complex so as to warrant evaluation whether such a function may be removed from a particular query. Conversely, if the result set is expected to be large (i.e., 1000s of rows) then the time required to analyze whether even a simple embedded function call may be removed may be worthwhile.

Similarly, even if only being run for a small result set, if database statistics 146 indicate that a query received at step 305 is run many times, then it may be worth determining whether one or more function calls may be removed. In one embodiment, DBMS 130 may allow an administrator to specify parameters used to decide when to evaluate whether the function calls may be removed for a particular query.

Returning to step 320 of method 300, if the query optimizer 134 determines not to evaluate a particular query, then the method 300 proceeds to step 330, where query is executed and query results are returned to the requesting application (e.g., query tool 108). At step 335, DBMS 130 may update database indexes and statistics 146 based on the results of a given query.

Otherwise, the method 300 proceeds to step 335 where the query optimizer 134 evaluates the embedded function calls to determine whether they may be removed from the database query, without changing the query results returned to the requesting application. One embodiment of a method for evaluating the function calls in a database query is described below in reference to FIG. 4. After any unnecessary function calls have been removed, at step 330, the query engine 132 executes the query and returns query results to the requesting application. This includes performing any function calls that were not removed as a result of the evaluation performed at step 325. At step 335, DBMS 130 may update database indexes and statistics 146 based on the results of a query.

FIG. 4 illustrates a method 400 for evaluating function calls embedded within a database query, according to one embodiment of the invention. At step 405, the query optimizer 134 may determine whether to remove an embedded function call based on the data type of the column being passed to the function. For example, database queries generated using query building tools (e.g., query tool 108) often include redundant, or unnecessary, data type casts. As an example of this, the query 225 illustrated in FIG. 2B includes a call to the casting function TO_CHAR 208 being passed the values from an LNAME column 210 of a demographics table 212. Assume that the demographics table is defined by database schema 144 as a character field column and is used to store an individual's last name. By being defined as a character column, performing the TO_CHAR function 208 will not modify any data values, and is thus, unnecessary. Accordingly, the TO_CHAR function 208 function may be removed during a query rewriting stage. In contrast, the WHERE clause 206 of query 225 also includes an embedded call to the UPPER function 214. Specifically, the UPPER function 214 is passed values from the LNAME column 210 which are compared with a string literal value of “SMITH”. Because the LNAME column 210 may include characters in both upper and lower case, removing this function may change query results. In particular, if a string comparison checks both letter and case, than an LNAME value of “Smith” would not equal the string literal of “SMITH.” Accordingly, the query optimizer 134 will not remove the embedded call to the UPPER function 214 during a query rewriting step.

Returning to the method 400 of FIG. 4, at step 410, the query optimizer 134 may determine whether to remove an embedded function call based on database statistics 146. For example, database query 250 illustrated in FIG. 2C includes a call to an ABS function 216 (absolute value) being passed the values from an AGE column 218 of the demographics table 212. Assume that the AGE column 218 is defined to store an integer representing the chronological AGE of an individual. By being defined as an integer, the AGE column 218 may support negative integer values, even though in this case, no negative values should actually occur. Database statistics 146 may reflect this by tracking a minimum and maximum value for each column. In such a case, if database statistics indicate 146 that the minimum value in a column is not less than zero, then the ABS function is unnecessary and this function may be removed during a query rewriting stage. Illustratively, other built in functions may be potentially removed based on database statistics 146 include IS_DIGITS, IS_CHAR, and IS_NULL, among others.

Returning to the method 400 of FIG. 4, at step 415, the query optimizer 134 may determine whether to remove an embedded function call based on database schema 144. For example, database query 275 illustrated in FIG. 2C includes a call to a COALESCE function 222 being passed the values from a salary column 224 of an employee table 226. When executed, query 275 returns an employee ID and salary from all the rows in the EMPLOYEE table 228 (where any conditions specified by WHERE clause 206 are satisfied). The COALESCE function 222 specifies that if a value for salary is missing from a particular row, (i.e., is null), then a value of zero should be returned. However, database schema 144 may include constraints on what values may (or must) or may not be stored in the column of a table. Assume for this example that database schema 144 includes a constraint for the salary column 224 specifying that the column cannot be null (i.e., each row of the employee table must include a value for the salary column 224). In such a case, then the COALESCE function 222 will return the actual salary and never the alternate value of 0, as no “null” rows will ever be encountered during query processing. In such a case, the COALESCE function 222 may be removed during a query rewriting stage.

Returning to the method 400 of FIG. 4, at step 420, the query optimizer 134 may determine whether to remove an embedded function call based on calculations performed relative to a particular column or field referenced by the database query. For example, consider again the database query 250 illustrated in FIG. 2B. Before performing the ABS function 216 on a large number of rows, the query optimizer 134 may be configured to calculate a minimum value stored in the AGE column 218. If the query optimizer 134 determines that the smallest value is greater than zero (which should be the case for a column that stores an individual's chronological age), then the query optimizer 134 may remove the ABS function 21 6 during a query rewriting stage.

As described above in regards to steps 405 through 420 of the method 400, the query optimizer 134 may evaluate whether embedded function calls may be removed from a database query using a variety of evaluation mechanisms. Those skilled in the art will recognize however, that not each of the steps 405-420 may be performed to evaluate a particular database query. For example, step 405 evaluates a query based on a particular type of embedded function, if a query being evaluated does not include an embedded function of this type, then this step may be omitted.

Further, the different evaluation mechanisms shown being performed as part of steps 405-420 are provided as examples of evaluation mechanisms that may be used to evaluate a particular database query. Those of skill in the art will readily recognize, however, that other evaluation mechanism may be performed to determine whether a particular type of function call, or a function call from a particular query, may be removed without changing the query results that will be returned for the query.

At step 425 after performing the evaluations on a particular database query, the query optimizer 134 may rewrite the database query to remove any unnecessary embedded function calls. That is, any function calls that will not affect the results of the query are removed.

Advantageously, embodiments of the invention provide a mechanism to remove one or more function calls included in a database query when the function calls will not impact query results. Doing so may improve system performance, as the system omits performing unnecessary function calls.

While the foregoing is directed to embodiments of the present invention, other and further embodiments of the invention may be devised without departing from the basic scope thereof, and the scope thereof is determined by the claims that follow.

What is claimed is:

1. A computer-implemented method of optimizing a database query comprising:
receiving a query of a database, wherein the query includes one or more embedded function calls;
determining whether one or more of the embedded function calls may be removed without modifying a set of results that will be generated in response to the database query; and
if so, rewriting the database query to remove one or more of the embedded function calls.

2. The method of claim 1, wherein determining whether one or more of the embedded function calls may be removed comprises evaluating the embedded function call based on a data type of a column passed as a parameter to the function call.

3. The method of claim 1, wherein determining whether one or more of the embedded function calls may be removed comprises evaluating database statistics related to a set of data values stored in the database.

4. The method of claim 1, wherein determining whether one or more of the embedded function calls may be removed comprises evaluating database constraints specified by a schema of the database.

5. The method of claim 1, wherein determining whether one or more of the embedded function calls may be removed comprises performing calculations regarding a particular column or a particular field referenced by the query.

6. The method of claim 1, further comprising, prior to determining whether the embedded function call may be removed, determining whether performing the embedded function call will exceed a specified execution cost.

7. The method of claim 1, wherein the database is a relational database and the query is composed in the Structured Query Language (SQL).

8. The method of claim 1, further comprising, executing the rewritten database query to retrieve the set of query results.

9. A computer-readable medium containing a program which, when executed, performs an operation, comprising:
receiving a query of a database, wherein the query includes one or more embedded function calls;
determining whether one or more of the embedded function calls may be removed without modifying a set of results that will be generated in response to the database query; and
if so, rewriting the database query to remove one or more of the embedded function calls.

10. The computer-readable medium of claim 9, wherein determining whether one or more of the embedded function calls may be removed comprises evaluating the embedded function call based on a data type of a column passed as a parameter to the function call.

11. The computer-readable medium of claim 9, wherein determining whether one or more of the embedded function calls may be removed comprises evaluating database statistics related to a set of data values stored in the database.

12. The computer-readable medium of claim 9, wherein determining whether one or more of the embedded function calls may be removed comprises evaluating database constraints specified by a schema of the database.

13. The computer-readable medium of claim 9, wherein determining whether one or more of the embedded function calls may be removed comprises performing calculations regarding a particular column or a particular field referenced by the query.

14. The computer-readable medium of claim 9, wherein the operations further comprise, prior to determining whether the embedded function call may be removed, determining whether performing the embedded function call will exceed a specified execution cost.

15. The computer-readable medium of claim 9, wherein the database is a relational database and the query is composed in the Structured Query Language (SQL).

16. The computer-readable medium of claim 9, wherein the operations further comprise, executing the rewritten database query to retrieve the set of query results.

17. A computing device, comprising:
a processor; and
a memory containing a program for optimizing a database query, which, when executed, performs an operation, comprising:
receiving a query of a database, wherein the query includes one or more embedded function calls;
determining whether one or more of the embedded function calls may be removed without modifying a set of results that will be generated in response to the database query; and
if so, rewriting the database query to remove one or more of the embedded function calls.

18. The computing device of claim 17, wherein determining whether one or more of the embedded function calls may be removed comprises evaluating the embedded function call based on a data type of a column passed as a parameter to the function call.

19. The computing device of claim 17, wherein determining whether one or more of the embedded function calls may be removed comprises evaluating database statistics related to a set of data values stored in the database.

20. The computing device of claim 17, wherein determining whether one or more of the embedded function calls may be removed comprises evaluating database constraints specified by a schema of the database.

21. The computing device of claim 17, wherein determining whether one or more of the embedded function calls may be removed comprises performing calculations regarding a particular column or a particular field referenced by the query.

22. The computing device of claim 17, wherein the operations further comprise, prior to determining whether the embedded function call may be removed, determining whether performing the embedded function call will exceed a specified execution cost.

23. The computing device of claim 17, wherein the database is a relational database and the query is composed in the Structured Query Language (SQL).

24. The computing device of claim 17, wherein the operations further comprise, executing the rewritten database query to retrieve the set of query results.
